(19) United States
(12) Patent Application Publication
(10) Pub. No.: US 2015/0302637 A1
(43) Pub. Date: Oct. 22, 2015

(54) LIGHTING PERFORMANCE SIMULATION AND ANALYSIS IN ARCHITECTURAL MODELING ENVIRONMENTS

(71) Applicant: Light Foundry, LLC, Boulder, CO (US)

(72) Inventor: Daniel C. Glaser, Boulder, CO (US)

(21) Appl. No.: 14/685,493

(22) Filed: Apr. 13, 2015

Related U.S. Application Data
(60) Provisional application No. 61/980,687, filed on Apr. 17, 2014.
(60) Provisional application No. 62/004,714, filed on May 29, 2014.
(60) Provisional application No. 62/144,191, filed on Apr. 7, 2015.

(51) Int. Cl. G06T 15/50; G06T 15/06

(52) U.S. Cl. CPC G06T 15/506; G06T 15/06

(57) ABSTRACT

Embodiments provide platforms and techniques for, modeling, simulating, and/or analyzing lighting, including daylighting, in architectural spaces. For example, lighting performance properties can be associated with structural components defined as building geometry of architectural space models, and environmental daylighting models can be formulated in association with designated geographical locations and orientations, and keytimes. A lighting rendering engine can compute lighting rendering data by ray-tracing the architectural space model as a function of the structural components, the lighting performance properties, and the environmental daylighting model at each keytime. The lighting rendering data can be used to output images can be output that graphically represent, for each keytime, a depiction of the architectural space model and a distributed lighting performance metric.

### COLOR DRAWINGS

The patent or application file contains at least one drawing executed in color. Copies of this patent or patent application publication with color drawings will be provided by the Office upon request and payment of the necessary fee.

### BACKGROUND

Embodiments relate generally to multi-dimensional modeling and simulation, and, more particularly, to simulation and analysis of lighting performance in architectural modeling environments.

Lighting plays an integral role in the design of architectural spaces. The lighting design can include selection and placement of windows, lighting fixtures, skylights, tubular daylight devices, and other design elements that generate light and/or control (e.g., allow, filter, block, etc.) entry of natural lighting into a space. In addition, though often not considered as part of the lighting design, many other features of the architectural space can also impact the effectiveness, feel, and/or other attributes of the lighting, including, for example, paint colors and finishes; wall textures and materials; furniture shapes, sizes, and materials, flooring colors, finishes, and materials; etc. Architects and other designers often desire to predict how an architectural space will look and perform under different lighting conditions (e.g., with different lighting fixtures turned on and off, positioned differently, etc.; with different windows; at different hours of the day and/or time of year; etc.). Further, designers and other stakeholders (e.g., energy auditors, etc.) increasingly desire to understand how the lighting design will impact energy consumption and/or other related parameters.

### BRIEF SUMMARY

Among other things, systems and methods are described for, modeling, simulating, and/or analyzing daylight in architectural spaces. Some embodiments operate in context of a platform in which architectural spaces can be modeled with various lighting designs, including elements that impact flow of natural light and/or provide artificial light in an architectural space, in a manner that can be easily manipulated. The platform can provide simulated visualizations of the architectural space under a variety of lighting conditions, including artificial and/or natural lighting elements, and can account for modeled elements of one or more spaces (e.g., rooms) in a building or other architectural space (e.g., furniture, wall color, etc., and/or materials, such as glazing, surface finishes, material reflectance or transparency, etc.). Some embodiments can further account for various contextual conditions, such as site location (e.g., geography, altitude, climate zone, etc.), site orientation (e.g., north angle, etc.), various existing exterior conditions (e.g., adjacent and/or otherwise interfering structures, foliage, etc.), etc. Implementations can also facilitate simulation and analysis of lighting energy consumption, light distribution, and/or other effects of the lighting design, for example, at different times of day and/or times of year, in formats that facilitate standard audits or compliance checks, etc. Some embodiments further operate in context of a file system that facilitates a parameter-based approach to the modeling, simulation, and analysis of lighting designs. For example, design models can be used in simulation and analysis at a model level, a sub-model level, a super-model level, etc., and those outputs can be intuitively displayed to facilitate further analysis, comparison, design, etc.

According to one set of embodiments, a method is provided for simulation and analysis of lighting performance in architectural modeling environments. The method includes: associating, with a processor-implemented lighting modeling engine, lighting performance properties with a plurality of structural components defined as building geometry of an architectural space model in a three-dimensional computer-aided design (3D CAD) environment; formulating an environmental daylighting model associated with a designated geographical location for the architectural space model, a designated orientation for the architectural space model, and a plurality of keytimes; communicating the architectural space model and the environmental daylighting model to a lighting rendering engine remote from the lighting modeling engine; receiving, at the lighting modeling engine from the lighting rendering engine, lighting rendering data computed by the daylighting rendering engine by ray-tracing the architectural space model as a function of the structural components, the lighting performance properties, and the environmental daylighting model at each keytime; and outputting, via an interface of the lighting modeling engine, a plurality of images, each graphically representing, for a respective one of the keytimes, a depiction of the architectural space model and a distributed lighting performance metric computed as a function of the lighting rendering data.

### BRIEF DESCRIPTION OF THE DRAWINGS

The present disclosure is described in conjunction with the appended figures:

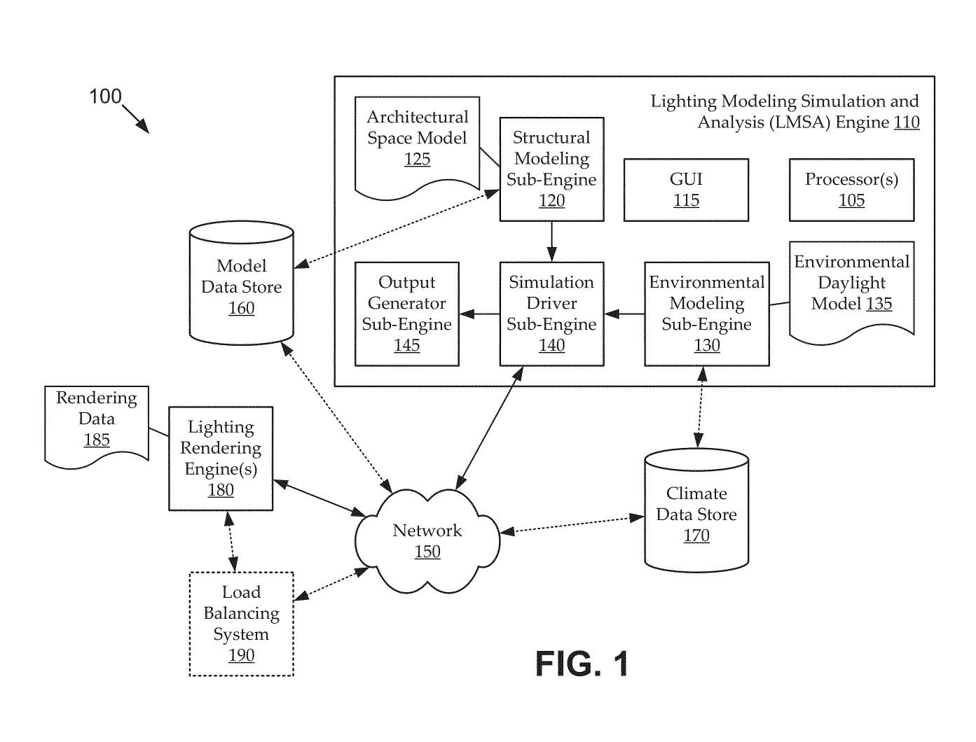

FIG. 1 shows a simplified diagram of a lighting simulation and analysis system, according to various embodiments;

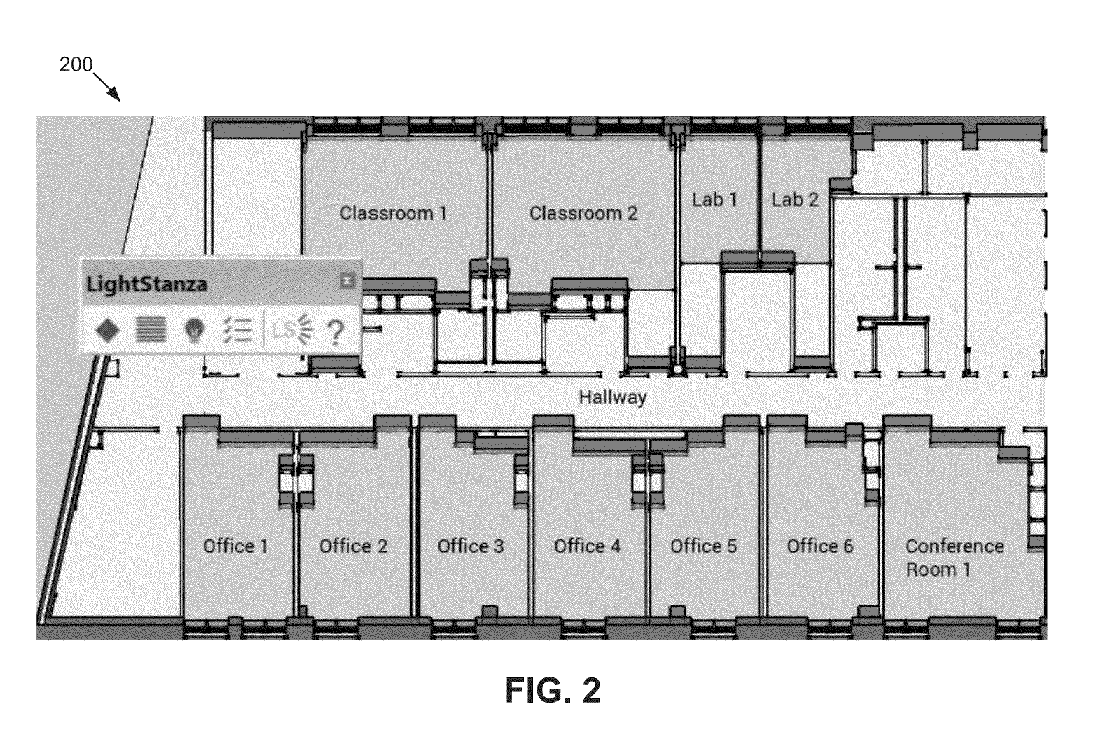

FIG. 2 shows an illustrative screenshot of a three-dimensional computer-aided design (3D CAD) modeling environment having an instance of the structural modeling sub-engine operating as a plug in;

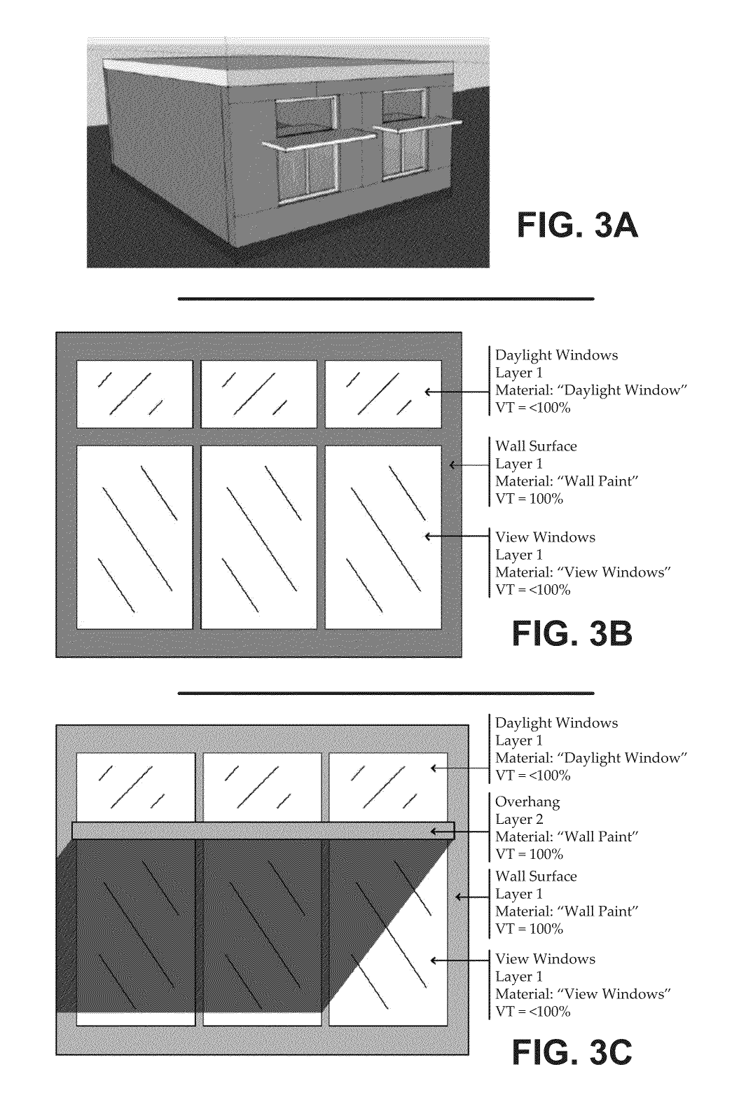

FIGS. 3A-3C show illustrative screenshots of an application that permits association of lighting performance properties with the structural components

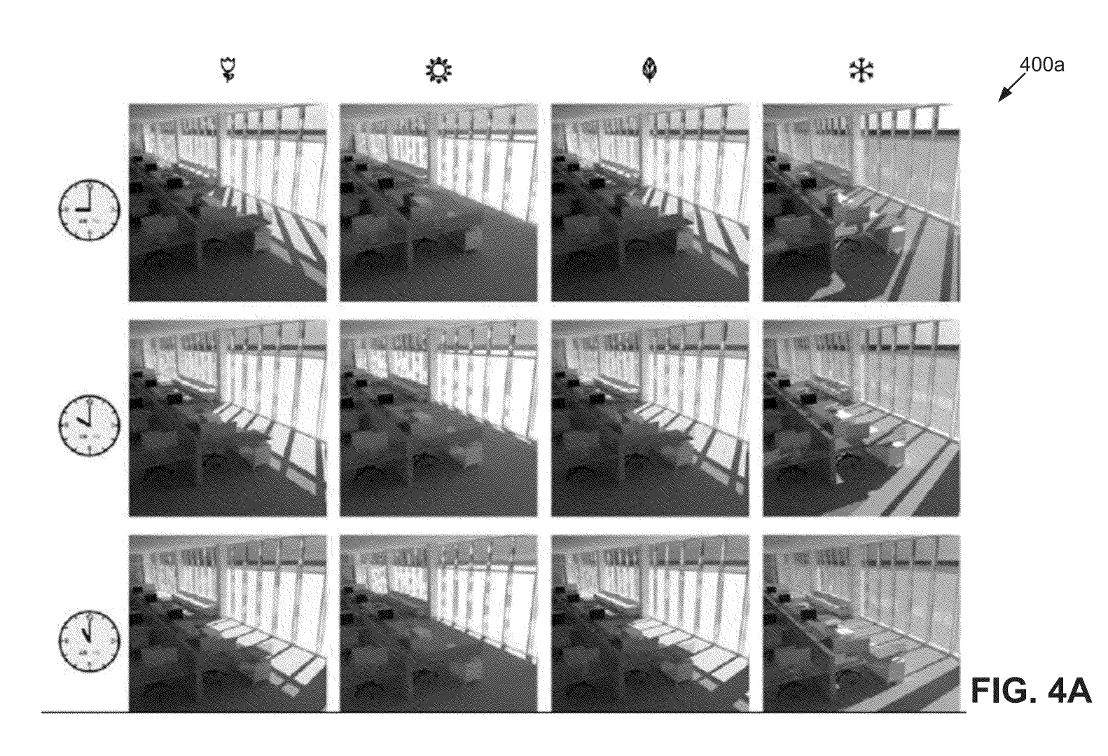

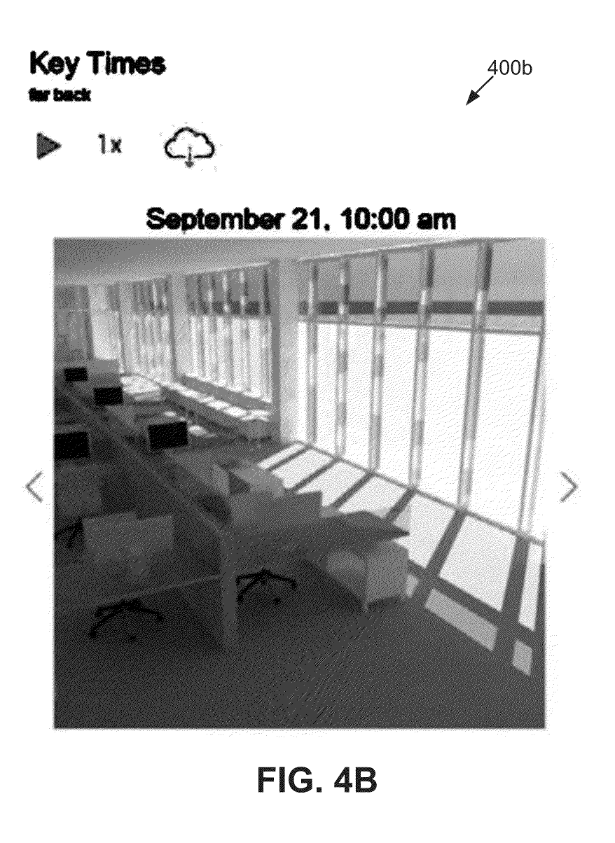

FIG. 4A shows an illustrative screenshot of an array of output images from a lighting simulation representing various keytimes;

FIG. 4B shows an illustrative screenshot that includes an enlarged view of the output image from FIG. 4A on September 21 at 10:00 am;

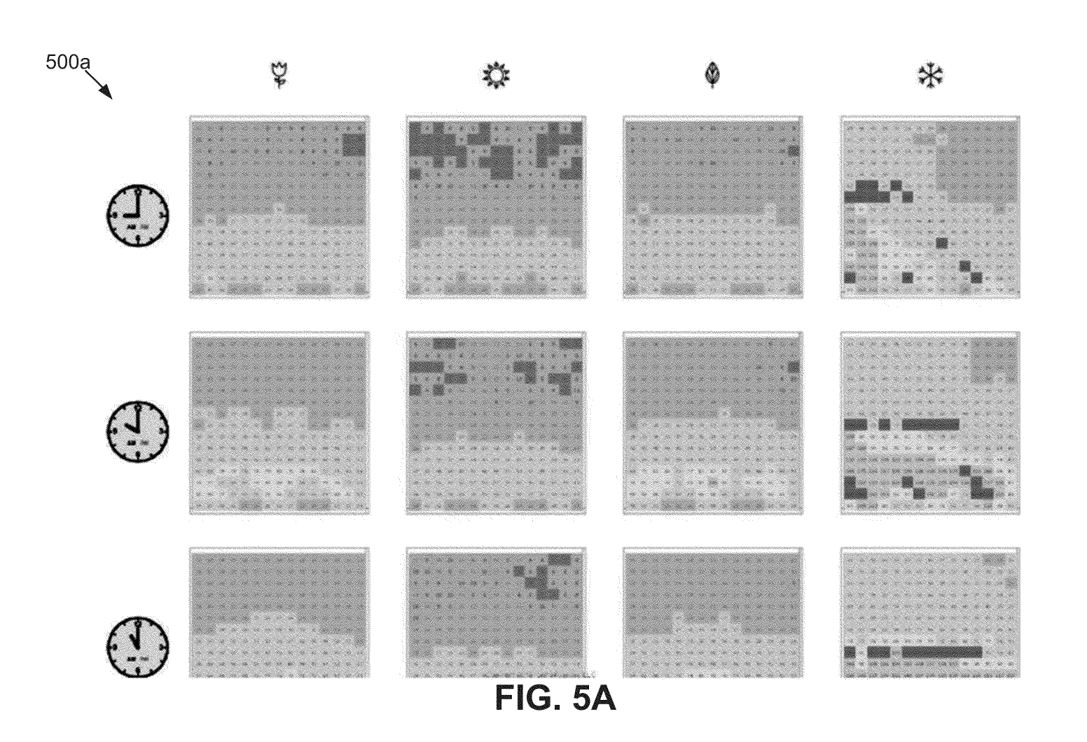

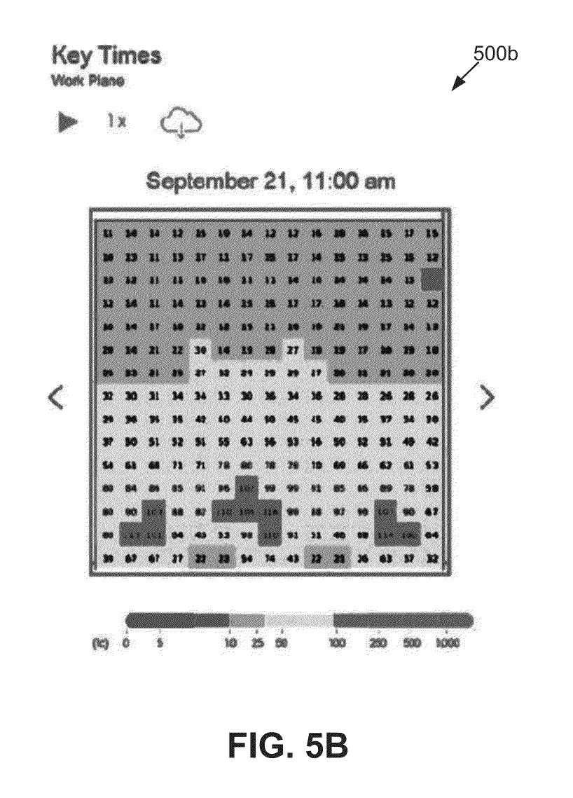

FIG. 5A shows an illustrative screenshot of an array of output images from a lighting simulation representing various keytimes;

FIG. 5B shows an illustrative screenshot that includes an enlarged view of the output image from FIG. 5A on September 21 at 11:00 am;

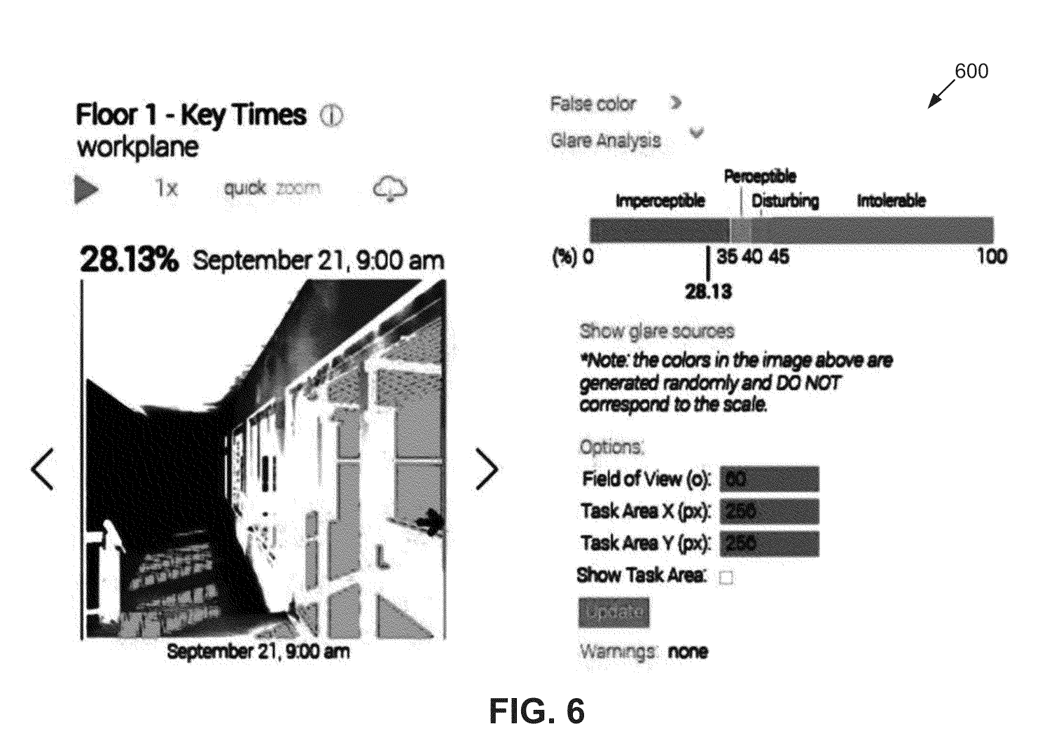

FIG. 6 shows an illustrative screenshot that includes a depiction of a portion of an interior space on September 21 at 9:00 am;

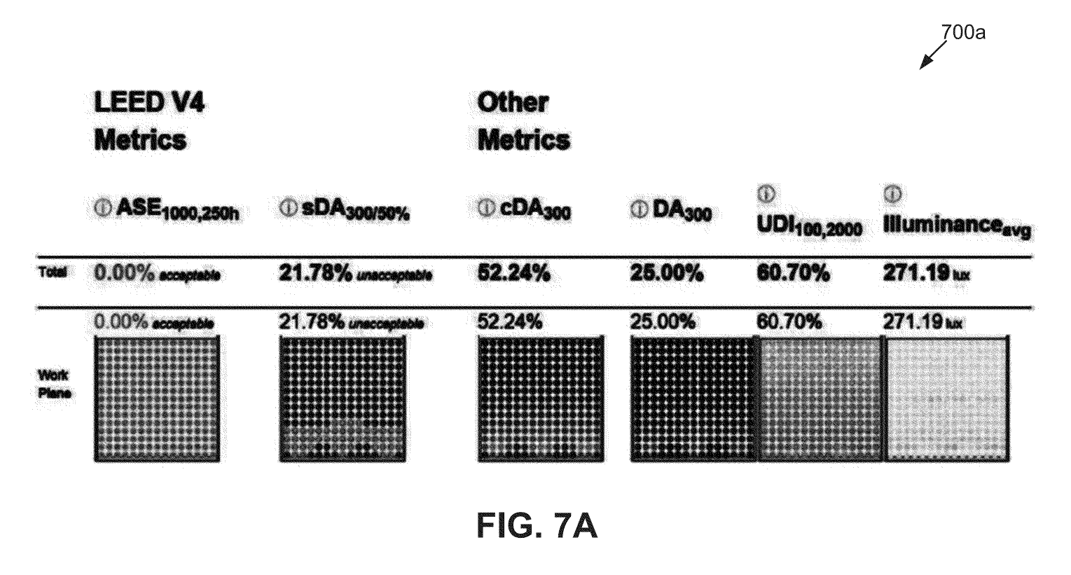

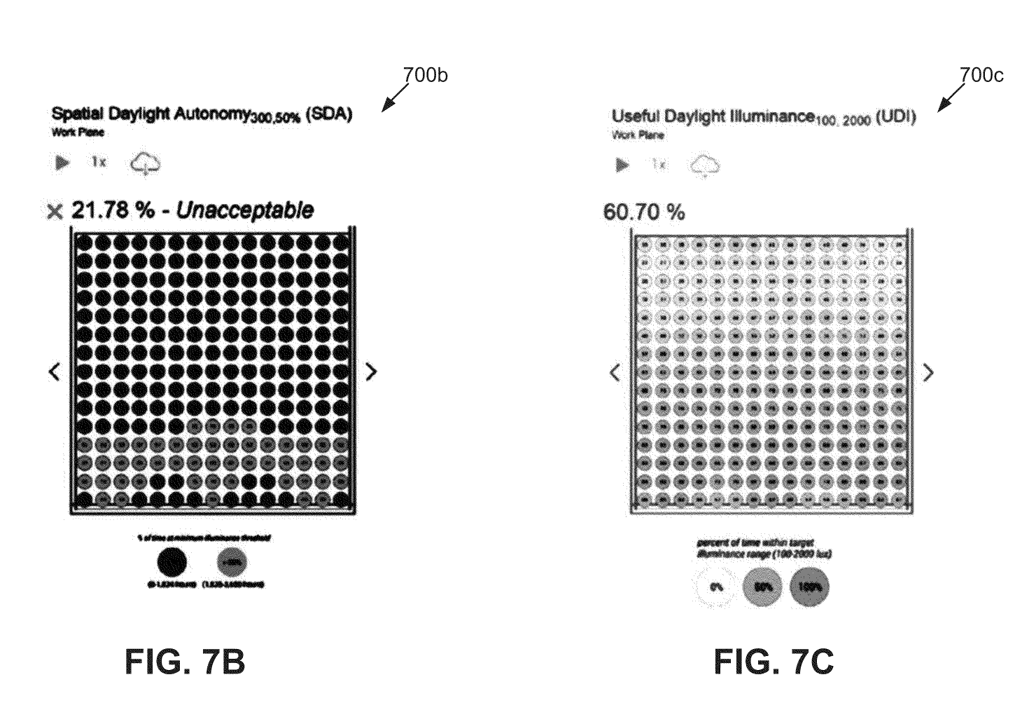

FIG. 7A shows an illustrative screenshot that includes a number of metrics for a particular architectural space;

FIG. 7B shows an illustrative screenshot that includes an enlarged view of the output image from FIG. 7A relating to Spatial Daylight Autonomy;

FIG. 7C shows an illustrative screenshot that includes an enlarged view of the output image from FIG. 7A relating to Useful Daylight Illuminance;

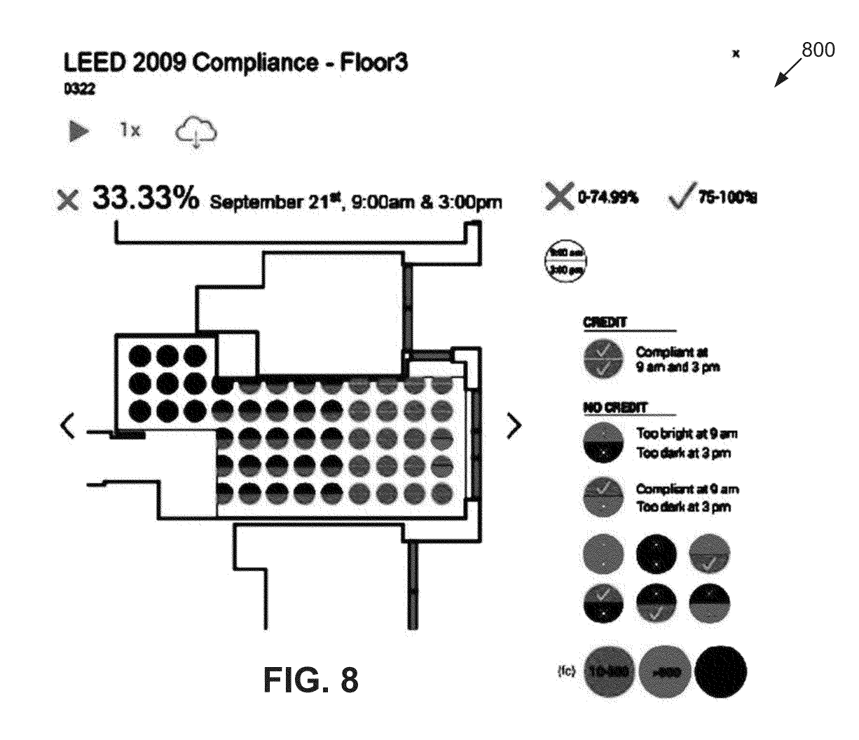

FIG. 8 shows an illustrative screenshot that includes a number of metrics for an illustrative standard (e.g., LEED 2009 is shown) compliance for a particular architectural space;

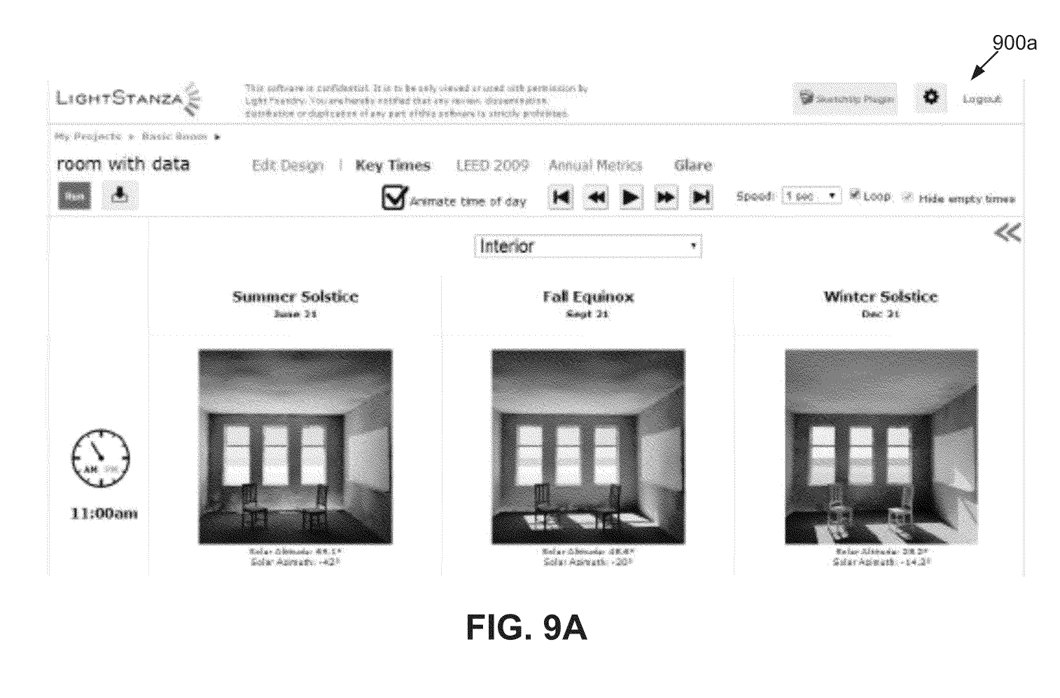

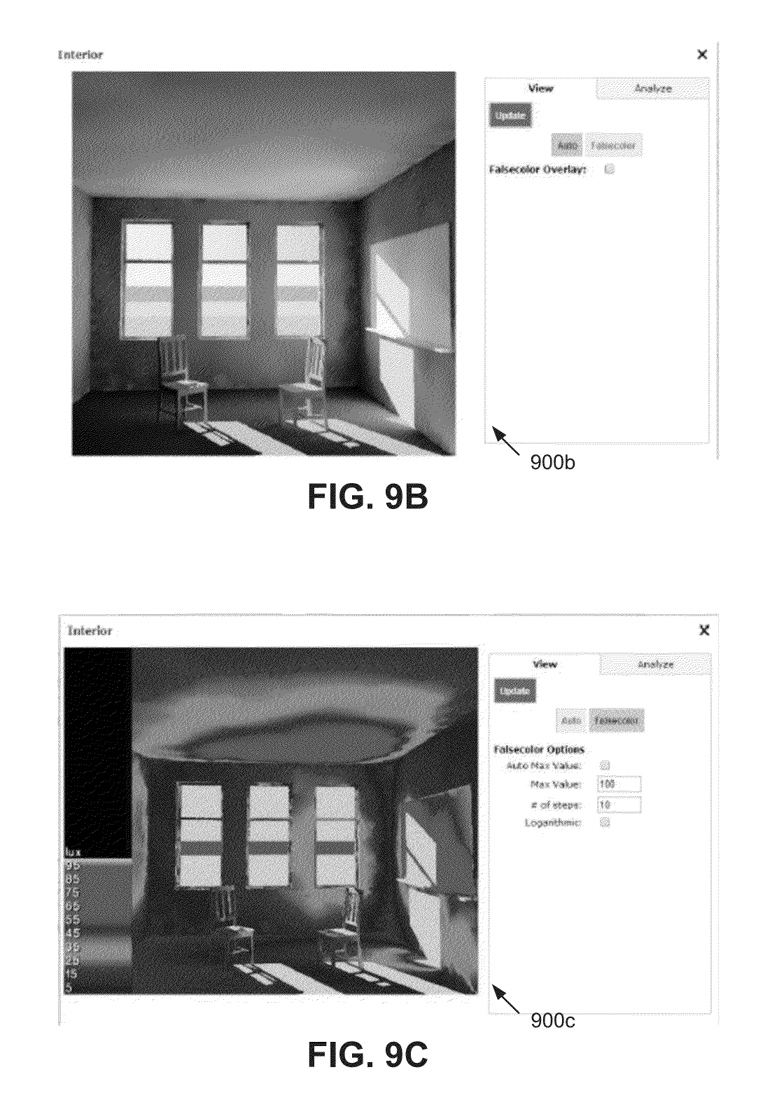

FIG. 9A shows an illustrative screenshot that includes a number of juxtaposed renderings of an architectural space as it is simulated to appear at 11:00 am on the summer solstice, the fall equinox, and the winter solstice;

FIGS. 9B and 9C show illustrative screenshots and that include enlarged views of the architectural space at a particular keytime without and with false color overlay, respectively;

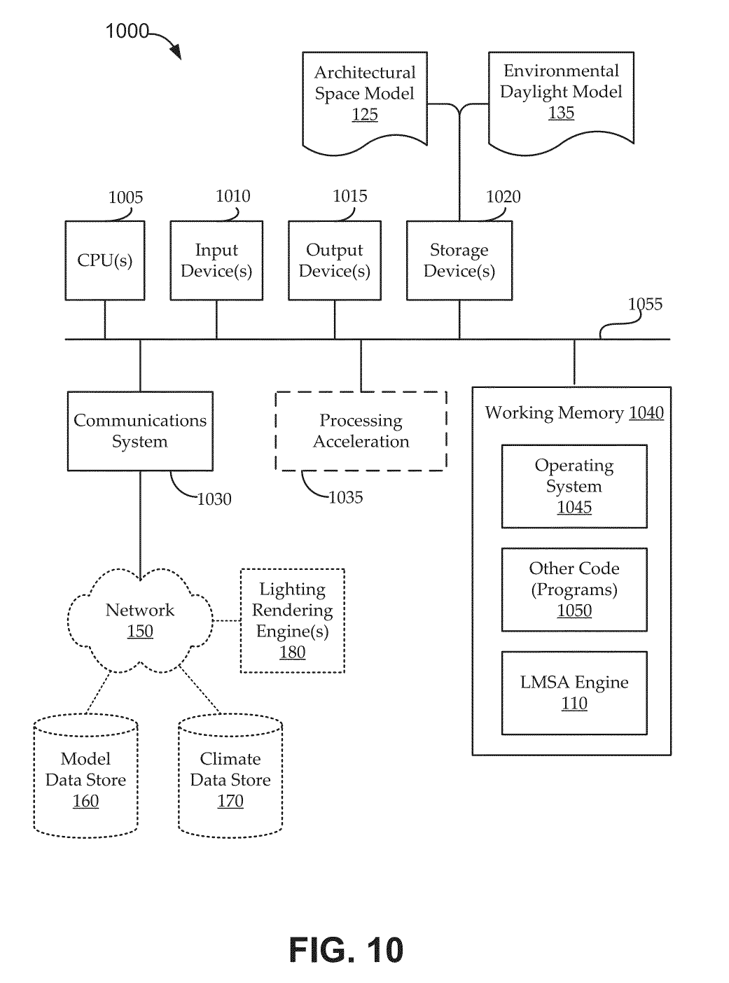

FIG. 10 shows an illustrative computational system for implementing one or more systems or components of systems, according to various embodiments; and

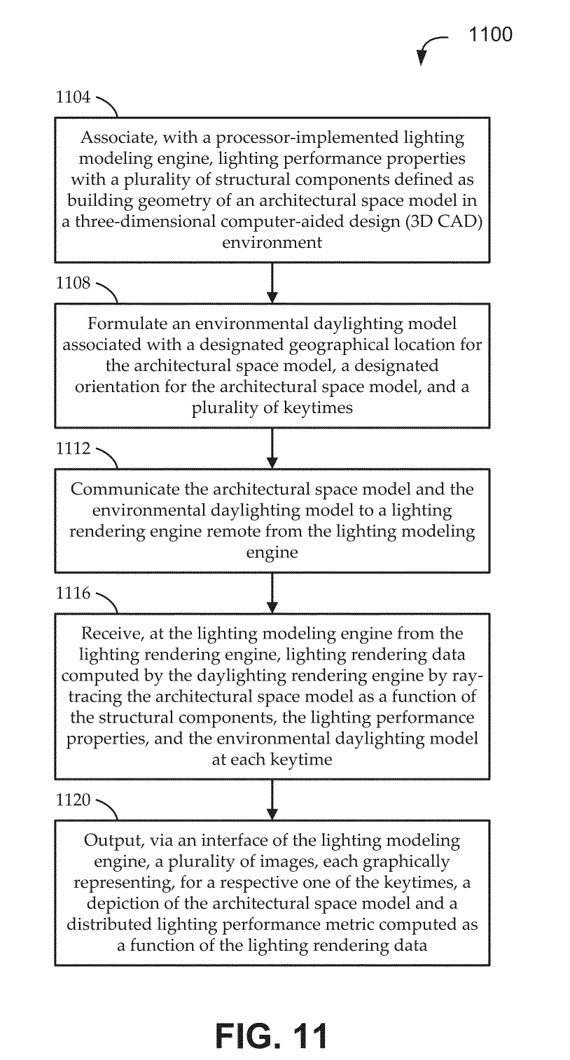

FIG. 11 shows a flow diagram of an illustrative method for simulation and analysis of lighting performance in architectural modeling environments, according to various embodiments.

In the appended figures, similar components and/or features can have the same reference label. Further, various components of the same type can be distinguished by following the reference label by a second label that distinguishes among the similar components. If only the first reference label is used in the specification, the description is applicable to any one of the similar components having the same first reference label irrespective of the second reference label.

### DETAILED DESCRIPTION

In the following description, numerous specific details are set forth to provide a thorough understanding of the present invention. However, one having ordinary skill in the art should recognize that the invention can be practiced without these specific details. In some instances, circuits, structures, and techniques have not been shown in detail to avoid obscuring the present invention.

FIG. 1 shows a simplified diagram of a lighting simulation and analysis system 100, according to various embodiments. Embodiments of the lighting simulation and analysis system 100 include a lighting modeling, simulation and analysis (LMSA) engine 110 in communication with a lighting rendering engine 180 over a network 150. The LMSA engine 110 can also be in communication (e.g., directly and/or over the network 150) with one or more data storage systems, for example, including a model data store 160 and a climate data store 170. Embodiments of the LMSA engine 110 include a structural modeling sub-engine 120, an environmental modeling sub-engine 130, a simulation driver sub-engine 140, and an output generator sub-engine 145.

The LMSA engine 110 can include one or more processors 105. The processor(s) 105 can implement functions described herein using integrated hardware, by directing operation of other hardware and/or by executing instructions, or the like from software components and/or other components. The various functional blocks shown in FIG. 1, including the various engines and sub-engines, can include hardware and/or software component(s) and/or module(s), including, but not limited to circuits, application specific integrated circuits (ASICs), general purpose processors, digital signal processors (DSPs), field programmable gate arrays (FPGAs), programmable logic devices (PLD), discrete gates, transistor logic devices, discrete hardware components, or combinations thereof. For example, steps of methods or algorithms, or other functionality described in connection with embodiments, can be embodied directly in hardware, in a software module executed by a processor, or in a combination of the two. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media. Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material. Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Embodiments of the structural modeling sub-engine 120 can be implemented in any suitable manner for interacting with a three-dimensional computer-aided design (3D CAD) modeling environment. For example, the structural modeling sub-engine 120 can be part of a 3D CAD modeling environment, a plug-in to a 3D CAD modeling environment, etc. For example, FIG. 2 shows an illustrative screenshot 200 of a 3D CAD modeling environment having an instance of the structural modeling sub-engine 120 operating as a plug in. The 3D CAD modeling environment includes various structural components that define architectural spaces, such as offices, classrooms, hallways, etc. Some implementations facilitate use of “smartmodels” to make the modeling process more organized and efficient. For example, to test different designs, typical approaches force user to build a separate model for each design and to run simulations on each model individually. The smartmodel can be an inclusive model that contains multiple (e.g., all) design options organized (e.g., by layer and material), which can be activates and manipulated as simulations are run to test design strategies. For example, many parametric variations can be provided to the simulation driver sub-engine 140 for running a number of different simulations on the same model under varying parameters. Other concepts, such as “super models,” or the like, can be included in certain implementations to facilitate toggling of layers, materials, and/or other properties for more efficient modeling and simulation. For example, if testing three different strategies for windows, all three can be modeled as part of the smart model (e.g., on separate layers), the smartmodel can be exported and uploaded once, and layers can be toggled for different simulations. As another example, a particular window configuration can be simulated with different overhang strategies, including various horizontal and vertical overhangs, which can be tried separately, together, and/or in any useful combination. As yet another example, a particular window can be simulated with different materials that manifest as a 70% visible transmittance, then 60% visible transmittance, then 40% translucent glazing.

Returning to FIG. 1, the 3D CAD modeling environment can include structural components defined as building geometry 165 (e.g., stored in the model data store 160). For example, the building geometry 165 can define architectural spaces (e.g., rooms of a building, floors (or other collections of spaces) of a building, exterior structures, etc.) with various types of structural components, such as walls (e.g., including doors, ceilings, floors, partial walls, etc.), windows (e.g., including partial or full windows, daylight windows, glass blocks, skylights, etc.), louvres, etc. As used herein, terms like “building,” “architectural spaces,” “structural components,” etc. are intended to be construed broadly. For example, a “building” could be a residential and/or commercial building, a manufacturing facility, a storage facility (e.g., a warehouse, a water tower, etc.), an amphitheater, a gazebo, etc. Further, structural components can include features relating to the structure that can impact illuminance and/or other lighting-related characteristics of the architectural space, such as landscaping (e.g., a tree that provides shade, etc.), other features not contiguous with the building (e.g., a phone poles, gazebos, other nearby structures, etc.), window treatments (e.g., blinds, curtains, coverings, laminates, etc.), furniture and/or other internal features of the architectural space (e.g., a large glass table, a wall mirror, a water wall, a couch, and/or other features can impact lighting), artificial lighting (e.g., lights, sconces, lamps, flood lights, etc.), and/or other lighting components (e.g., skylights, solar tubes, etc.). For example, embodiments can be used to simulate lighting in an urban environment where multiple neighboring structures, roadways, etc. can impact each other's lighting; to simulate lighting performance of an outdoor amphitheater or other space (e.g., as impacted by its own structures and surrounding structures); etc.

Some embodiments include additional advanced functionality. For example, some implementations use Bidirectional Scattering Distribution Functions (BSDFs) to describe mathematically how light is scattered by surfaces. Using preset BSDF files can allow users to avoid physically modeling complex components, like blinds or daylight, and instead provide libraries of measurements for complex fenestration and daylighting products for integration into the building geometry 165. Some implementations can account for thicknesses of walls and/or other structural components of the building geometry 165 (e.g., mullion details in windows), which can appreciably increase the realism in renderings and accuracy in daylighting analysis calculations. Some implementations can further simulate for advanced windows, for example, to test a window with daylight film, blinds, and/or other features. In certain such implementations, users can create each element as its own plane, each modeled on a respective layer, and each having its own unique material assignment (e.g., glass, daylight film, blinds, etc.). Layers can then be toggled in different simulations to test the different combinations. Some embodiments enable other complex analyses, such as impacts of automatic blinds, photosensors, traffic patterns, etc. In one implementation, annual and/or other metrics for lighting performance (e.g., including energy performance, etc.) can be computed according to formulas that account for automatic blinds that open or close automatically according to illumination level. In another implementation, annual and/or other metrics for lighting performance (e.g., including energy performance, etc.) can be computed according to formulas that account for photosensors and/or other electrical devices that control artificial lighting (e.g., turn the lights on or off automatically according to detecting presence of an occupant, according to timers, etc.), that control illuminated signage and/or emergency lighting, that control louvres and/or other elements, etc. Other implementations can account for changes in landscaping over seasons of the year (e.g., fullness of foliage, etc.), changes over time in occupancy of an architectural space (e.g., work hours, etc.), changes over time in traffic patterns (e.g., if close to a busy street, etc.), etc.

Embodiments of the structural modeling sub-engine 120 can permit a user to interface with structural components of a particular architectural space and to associate lighting performance properties with the structural components. For example, all, or relevant portions of, the building geometry 165 can be accessed by the structural modeling sub-engine 120 as an architectural space model 125, which can be displayed to a user via a graphical user interface (GUI) 115 of the LMSA engine 110. For the sake of illustration, FIGS. 3A-3C show illustrative screenshots of an application that permits association of lighting performance properties with the structural components. FIG. 3A shows a 3D CAD model of a building exterior having a partially glazed wall (i.e., a wall that is partially covered by windows). As illustrated in FIG. 3B, one version of the structure includes daylight windows and view windows in context of a wall, each defined with a respective material and visible transmittance property. As described herein, many other lighting performance properties can be included, such as RGB (red, green, and/or blue) transmittance, infrared and/or ultraviolet transmittance, opacity, specularity, texture, reflectance, refractance, etc.; and each can be expressed as an average over time, an average over the surface, a distributed function over time and/or the surface, etc. As illustrated in FIG. 3C, another version of the structure can further include an overhang having its own set of lighting performance properties. Some implementations can use layers in the 3D CAD model to quickly turn certain structural elements and/or other features on or off. For example, the overhang in FIG. 3C is shown as being on “layer 2,” while all the other structural components are on “layer 1.” In such an example, the overhangs can easily be included in, or excluded from, the simulation and analysis by toggling layer 2 on or off. Other implementations permit structural components to be added or removed, or other variations to be selected, toggled, etc., in any suitable manner.

Returning again to FIG. 1, embodiments of the environmental modeling sub-engine 130 can formulate an environmental daylighting model 135 that effectively defines the natural lighting conditions for simulation. In some implementations, the environmental daylighting model 135 is associated with a designated geographical location for the architectural space model, a designated orientation for the architectural space model, and a plurality of keytimes. The environmental daylighting model 135 can be defined in any suitable manner for use by the lighting rendering engine 180. For example, some embodiments implement the lighting rendering engine 180 as a local and/or remote (e.g., cloud-based, distributed, etc.) version of the RADIANCE Synthetic Imaging System (and/or any other suitable lighting rendering system). For example, one or more local clients can be installed as a mini-server on one or more client machines. In such implementations, the environmental daylighting model 135 can be defined as a “sky dome” or other numeric definition of the environmental data at each key time (e.g., any suitable, physically-based, analytical model of the sky at each keytime).

Each keytime can be a time of day, a time of year, and/or any other suitable designation. For example, some implementations permit selection of seasons (i.e., winter, spring, summer, autumn), calendar dates, times (e.g., 10:00 am, 3:00 pm, 1:15 pm, “sunrise,” “sunset,” etc.), etc. In certain implementations, the set of keytimes can be auto-generated according to other parameters, such as compliance with a defined standard (e.g., LEED and/or other standards may define compliance in relation to one or more particular times of day), a desired number of samples (e.g., the user selects “20 keytimes,” and the environmental modeling sub-engine 130 automatically selects five times spread evenly over a day in each of the four seasons), a preset or default, etc.

The designated orientation for the architectural space model can be selected in any suitable manner. For example, the 3D CAD modeling environment may include a definition of the geographic orientation of the modeled structure (e.g., in relation to “compass north,” or the like). Alternatively, some implementations of the environmental modeling sub-engine 130 permit a user to enter an orientation (e.g., numerically, by manipulating a rendering of the building geometry 165, etc.).

The designated geographical location can be defined in any suitable manner. For example, a user can be prompted (e.g., via the GUI 115) to select one of a number of preset geographic locations from a list or a map, click on a location of a map, enter a geographic place name (e.g., a city, state, etc.), enter a latitude and longitude, enter a landmark name (e.g., an airport, a weather station, etc.), etc. In some implementations, designating the geographical location involves receiving input from the user, then selecting (or offering selection of) one or more nearest preset locations. For example, a user can input a city and state, and the environmental modeling sub-engine 130 can identify a nearest weather station as the designated geographic location.

In some embodiments, additional information is included by the environmental modeling sub-engine 130 in the environmental daylighting model 135. Some implementations enable selection and/or definition of one or more clip planes that transect the architectural space model 125 at a defined position and angle. Other implementations enable one or more sky types to be selected and/or defined, such as a clear sky, an overcast sky, a sky to be generated based on climate data (e.g., average climate data and/or any other suitable function) for the designated location and keytime, etc. For example, daylighting data (e.g., position of the sun, average cloud cover, etc.) can be retrieved by the environmental modeling sub-engine 130 for the designated geographic location at each designated keytime. Other implementations enable one or more viewpoints to be selected and/or defined, such as “bottom up,” “top down,” “parallel to wall,” “diagonal,” “far back,” etc. Other implementations enable one or more camera types to be selected and/or defined, such as “perspective,” “parallel,” “hemispheric,” “angular,” “cylindrical,” “stereographic,” etc.

Embodiments of the simulation driver sub-engine 140 can communicate the architectural space model 125 and the environmental daylighting model 135 to the lighting rendering engine 180. For example, the simulation driver sub-engine 140 can format the models and/or other communications to be transmitted via the network 150 to the lighting rendering engine 180. Embodiments of the lighting rendering engine 180 can compute lighting rendering data 185 by ray-tracing the architectural space model 125 as a function of the structural components, the lighting performance properties, and the environmental daylighting model 135 at each keytime. Some embodiments can use additional and/or alternative techniques, such as scanline rendering approaches, where appropriate. The lighting rendering data 185 can include any suitable information, including rendered image data (e.g., shading, illumination, etc.) and/or mathematical measures (e.g., daylight coefficients, artificial light coefficients, illuminance measures, etc.).

As used herein, ray-tracing refers to any suitable technique for generating an image by tracing paths of light from one or more illumination sources through planes of an image (e.g., pixel-by-pixel) to compute and simulate the effects of the light on the illuminated virtual objects. Such techniques can yield highly realistic results, including reflection, refraction, dispersion, chromatic aberration, etc. Particularly where there are many structural objects and/or many associated lighting performance properties, the ray-tracing can involve large amounts of computation. Some embodiments include one or more techniques for optimizing the complex computational tasks. As illustrated, certain embodiments include a load balancing system 190. Some such systems can distribute the computational tasks associated with rendering among multiple instances of the lighting rendering engine 180. For example, the load balancing system 190 can distribute the model data to multiple web servers, which can input the model data to multiple queues in communication with respective instances of the lighting rendering engine 180. The computational tasks can thereby be performed in parallel.

The output of the lighting rendering engine 180 can be a set of lighting rendering data 185. In some embodiments, the output of the lighting rendering engine 180 includes output images computed from the lighting rendering data 185, which can be communicated back (e.g., via the network 150) to the LMSA engine 110. The images can be formatted for output, as desired, by the output generator sub-engine 145. In other embodiments, the lighting rendering data 185 itself can be communicated back (e.g., via the network 150) to the LMSA engine 110, and the output generator sub-engine 145 can compute and format the images. As used herein, “images” is intended to broadly include graphical outputs that depict the architectural space, such as a single two-dimensional image, a sequence of images, an animation or video, a three-dimensional image, a three-dimensional rendering that can be rotated or otherwise manipulated, etc.

The images can be computed (e.g., by the output generator sub-engine 145 and/or by the lighting rendering engine 180) to graphically represent, for each keytime, a depiction of the architectural space model and a distributed lighting performance metric. The images can be output in any suitable manner, for example, via the GUI 115. In some embodiments, outputting the images involves displaying the images in succession in such a way as to visually depict changes in the distributed lighting performance metric across the images. For example, the images can be shown as a slideshow or animation to visually highlight manners in which the lighting results change over the various keytimes. In other embodiments, outputting the plurality of images can involve displaying each image in juxtaposition to at least one other of the images in such a way as to visually depict changes in the distributed lighting performance metric across the juxtaposed images. For example, images can be shown side-by-side, in a tabular format, etc. Other embodiments can output at least one of images to graphically represent, for the respective one of the keytimes, the depiction of the architectural space model and the distributed lighting performance metric computed as a function of the lighting rendering data by displaying a two-dimensional rendered image of the architectural space model with the distributed lighting performance metric represented by variations in color across a plurality of regions of the image. For example, one color can represent a pleasant amount of illumination, while another color can represent excessive (e.g., uncomfortable) amounts of illumination. Other embodiments can output at least one of the images to graphically represent, for the respective one of the keytimes, the depiction of the architectural space model and the distributed lighting performance metric computed as a function of the lighting rendering data by displaying a two-dimensional rendered image of the architectural space model with the distributed lighting performance metric represented by numerical data overlaid on the image. For example, numbers distributed over an area of the architectural space depiction can indicate illumination levels, level of compliance with a standard, or any other suitable metric, score, value, etc.

Some implementations include various file management features. For example, embodiments organize projects, models, etc. in a file system metaphor (e.g., with folders, directories, etc.). Other embodiments permit users to share their models with others. For example, models can be shared through a file management system (e.g., checked in or out, revision controlled, etc.), with authorized user groups (e.g., according to defined roles and responsibilities, permissions, organizations, credentials, etc.), etc. Further, while FIG. 1 illustrates a particular system architecture, many other architectures are possible according to other embodiments. For example, functionality is ascribed above to particular functional blocks (e.g., sub-engines, etc.) for the sake of clarity and to describe some possible implementations; but the same or related functionality can alternatively be ascribed to different functional blocks, distributed among multiple functional blocks, etc. Further, while various data storage systems and the lighting rendering engine are shown as communicating with the LMSA engine over a network, other implementations can collocate some or all of those components, distribute them further, etc. Even further, some embodiments can implement functionality described herein in any suitable manner. For example, one implementation uses a thin client application on a mobile device to interface with a user, and the mobile device interacts with functionality of the LMSA engine via a network. In such implementations, certain functions can be managed by the thin client, such as the GUI 115, etc.

FIGS. 4A-11C show various illustrative outputs to demonstrate certain implementations of features, according to certain embodiments. The particular screenshot embodiments are intended only to add clarity to the description by illustrating certain implementations, but they are not intended to limit the scope of inventive embodiments. For example, a number of additional screenshots from certain illustrative implementations are shown in pending, commonly owned U.S. Provisional Patent Application No. 61/980,687; U.S. Provisional Patent Application No. 62/004,714; and U.S. Provisional Patent Application No. 62/144,191; all of which are incorporated herein by reference in their entirety.

Turning first to FIG. 4A, an illustrative screenshot 400a is shown of an array of output images from a lighting simulation representing various keytimes. As illustrated, each column indicates a season (i.e., Spring, Summer, Fall, Winter), and each row indicates a time of day (i.e., 9:00 am, 10:00 am, 11:00 am). Each image is a rendering output from the lighting rendering engine 180. It is evident from the images that the amount and location of illumination changes over the course of the day and over the course of the year, along with the changing position of the sun and/or other factors. FIG. 4B shows an illustrative screenshot 400b that includes an enlarged view of the output image from FIG. 4A on September 21 (i.e., Fall) at 10:00 am. As illustrated, the output can include additional information and/or controls, such as navigation buttons (e.g., arrows to move to a next or previous image), a camera type indicator (e.g., “far back” is indicated), other interaction buttons (e.g., a download button, etc.), etc.

FIG. 5A shows an illustrative screenshot 500a of an array of output images from a lighting simulation representing various keytimes. As illustrated, each column indicates a season (i.e., spring, summer, fall, winter), and each row indicates a time of day (i.e., 9:00 am, 10:00 am, 11:00 am). Each image graphically represents a depiction of an architectural space (e.g., a room), and illuminance level throughout the architectural space is indicated using colors and numbers. For example, colors closer to the purple end of the spectrum can indicate lower illuminance levels, and colors closer to the red end of the spectrum can indicate higher illuminance levels. It is evident from the images that the amount and location of illumination changes over the course of the day and over the course of the year. For example, at a particular time of day, the illuminance of the space tends to be lowest in the summer and highest in the winter, which can, for example, be desirable for improving the efficiency of cooling in the summer and of heating in the winter. FIG. 5B shows an illustrative screenshot 500b that includes an enlarged view of the output image from FIG. 5A on September 21 (i.e., Fall) at 11:00 am. As illustrated, the output can include additional information and/or controls, such as a legend. In this example, the camera type is defined in part by a workplane. A clip plane or other technique can be used to look at the distributed lighting metric as it interacts with a particular plane transecting the space. For example, it can be desirable in an office building to view the illuminance as it impacts a particular height of each room in which work is likely to be performed (e.g., a standard workplane height can be 30 inches above a finished floor), thereby obtaining information on how the illumination will impact the predicted work environment for occupants.

FIG. 6 shows an illustrative screenshot 600 that includes a depiction of a portion of an interior space on September 21 (i.e., Fall) at 9:00 am. The distributed lighting metric effectively indicates the quality of light in the space by color and numeric score. As illustrated, the illumination of the room on that day at that time is roughly 28 percent, which is on a high side of “imperceptible,” and far below “disturbing” or “intolerable.”

FIG. 7A shows an illustrative screenshot 700a that includes a number of metrics for a particular architectural space. For example, the illustrated set of metrics may include typical metrics of interest for a lighting designer, such as Annual Sunlight Exposure (e.g., “ASE” can be a simplified daylight simulation that only looks for direct sun, measuring illuminance values at each point based on a direct sun simulation, without including ambient or redirected light), Continuous Daylight Autonomy (e.g., “cDA” can measure how much of the time a room's lighting needs be met by daylight alone, providing partial credit for meeting a daylight illuminance threshold), Daylight Autonomy (e.g., “DA” can be similar to cDA, except no partial credit is given, which may be useful when looking at potentials for on/off electric switching systems), Spatial Daylight Autonomy (e.g., “sDA” can score a space's daylighting in conjunction with manual blind operation in a two-step process: the first step can determine the position of the blinds (whether they are open or closed); and the second step can measure daylight levels with the corresponding position of the blinds—for example, if more than 2% of the area inside receives direct sun, blinds close in groups until the percent drops to below 2%, and illuminance for the space can be calculated with the blinds on their determined position for each hour of the day, so that the final sDA score is a formula taking these raw illuminance values as input), Useful Daylight Illuminance (e.g., “UDI” can describe the percentage of the hours in a year that a point in space is within a range of acceptable illuminance values, with values that are too high or too low not being counted), Average Illuminance (e.g., “AI” can show the illuminance values in a space averaged over the 3,650 time points for which that annuals simulate), etc. Each can be displayed in a useful manner, for example, including a rolled up score next to a graphical representation of the distribution of the metric across the architectural space. FIG. 7B shows an illustrative screenshot 700b that includes an enlarged view of the output image from FIG. 7A relating to Spatial Daylight Autonomy. As illustrated, the overall score indicates an unacceptable result, while colors and numerical values distributed over the architectural space depiction show a percentage of time during which the space manifests a minimum threshold illuminance (e.g., gray is less than 50%, and orange is greater than 50%). FIG. 7C shows an illustrative screenshot 700c that includes an enlarged view of the output image from FIG. 7A relating to Useful Daylight Illuminance. As illustrated, the overall score indicates 60.7 percent, and colors and numerical values distributed over the architectural space depiction show a percentage of time during which the space is within a target illuminance range (e.g., darker green indicates a higher percentage of time within range).

FIG. 8 shows an illustrative screenshot 800 that includes a number of metrics for an illustrative standard (e.g., LEED 2009 is shown) compliance for a particular architectural space. While LEED is used herein, embodiments can be generally applied in context of any green building certification systems and building codes, or any other relevant metrics, codes, etc. The illustrated output graphically depicts the architectural space and distributed lighting metrics to indicate whether each region of the space is compliant with LEED 2009 at 9:00 am and 3:00 pm on September 21. For example, each colored circle within the architectural space has a top half to indicate compliance at 9:00 am (e.g., green for compliant, red for too bright, and grey for too dark), and a bottom half to indicate compliance at 3:00 pm (e.g., green for compliant, red for too bright, and grey for too dark). Overall, the space is shown to be only 33.33 percent compliant.

FIG. 9A shows an illustrative screenshot 900a that includes a number of juxtaposed renderings of an architectural space (a classroom) as it is simulated to appear at 11:00 am on the summer solstice, the fall equinox, and the winter solstice. It is evident from the rendered images that the illumination interacts with the windows, walls, whiteboard, furniture, and/or other elements of the space to form illumination patters, shadows, and the like. FIGS. 9B and 9C show illustrative screenshots 900b and 900c that include enlarged views of the architectural space at a particular keytime without and with false color overlay, respectively. For example, the image in FIG. 9B is rendered to illustrate an expected appearance of the classroom at the keytime, while the image in FIG. 9C is rendered to more clearly highlight illuminance levels across the classroom at the keytime. FIG. 9C can be useful, for example, in anticipating regions where glare, excessive illumination, heat, etc. may be problematic for occupants.

FIG. 10 shows an illustrative computational system 1000 for implementing one or more systems or components of systems, according to various embodiments. The computational system 1000 is described as a particular machine for implementing lighting modeling, simulation, and/or analysis functionality, like those described with reference to FIG. 1. Embodiments of the computational system 1000 can be implemented as or embodied in single or distributed computer systems, or in any other useful way. For example, some embodiments are implemented as a portable computer, such as a laptop, tablet, smart phone, etc.

The computational system 1000 is shown including hardware elements that can be electrically coupled via a bus 1055. The hardware elements can include one or more processors (shown as central processing units, “CPU(s)”) 1005, one or more input devices 1010 (e.g., a mouse, a keyboard, etc.), and one or more output devices 1015 (e.g., a display, a printer, etc.). For example, a display can be used to show the GUI 115 of FIG. 1. The computational system 1000 can also include one or more storage devices 1020. By way of example, storage device(s) 1020 can be disk drives, optical storage devices, solid-state storage device such as a random access memory (RAM) and/or a read-only memory (ROM), which can be programmable, flash-updateable and/or the like. In some embodiments, the storage devices 1020 are configured to store architectural space models 125, environmental daylight models 135, and/or any other suitable data.

The computational system 1000 can additionally include a communications system 1030 (e.g., a modem, a network card (wireless or wired) or chipset, an infra-red communication device, etc.). The communications system 1030 can permit data to be exchanged with a public or private network and/or any other system. For example, as shown in FIG. 1, the communications system 1030 can permit the LMSA engine 110 to communicate with a remote (e.g., cloud-based) lighting rendering engine 180 and/or with remote data storage systems (e.g., model data store(s) 160, climate data store(s) 170, etc.) via a public or private network 150 (shown in dashed lines for context). In some embodiments, the computational system 1000 can also include a processing acceleration unit 1035, which can include a DSP, a special-purpose processor and/or the like.

Embodiments can also include working memory 1040, which can include RAM and ROM devices, and/or any other suitable memory. The computational system 1000 can also include software elements, shown as being currently located within a working memory 1040, including an operating system 1045 and/or other code 1050, such as an application program (which can be a client application, web browser, mid-tier application, relational database management system (RDBMS), etc.). As illustrated, a LMSA engine 110 can be implemented in the working memory 1040.

In some embodiments, the storage device(s) 1020 implement a non-transient architectural space model in a three-dimensional computer-aided design (3D CAD) environment. Instructions in the working memory 1040 can be executed by the processor(s) 1005 of the computational system 1000 to perform various functions. For example, some embodiments operate to: associate lighting performance properties with a plurality of structural components defined as building geometry of the architectural space model; formulate an environmental daylighting model associated with a designated geographical location for the architectural space model, a designated orientation for the architectural space model, and a plurality of keytimes; communicate the architectural space model and the environmental daylighting model to a lighting rendering engine; receive, from the lighting rendering engine, lighting rendering data computed by the daylighting rendering engine by ray-tracing the architectural space model as a function of the structural components, the lighting performance properties, and the environmental daylighting model at each keytime; and output, via a graphical user interface, a plurality of images, each graphically representing, for a respective one of the keytimes, a depiction of the architectural space model and a distributed lighting performance metric computed as a function of the lighting rendering data.

It should be appreciated that alternate embodiments of computational system 1000 can have numerous variations from those described above. For example, customized hardware can be used and/or particular elements can be implemented in hardware, software (including portable software, such as applets), or both. Further, connection to other computing devices such as network input/output devices can be employed. In various embodiments a computational systems, like those illustrated in FIG. 7, can be used to implement one or more functions of the systems described with reference to FIG. 1 and/or to implement one or more methods, such as those described with reference to FIG. 11.

FIG. 11 shows a flow diagram of an illustrative method 1100 for simulation and analysis of lighting performance in architectural modeling environments, according to various embodiments. Embodiments of the method 1100 begin at stage 1104 by associating, with a processor-implemented lighting modeling engine, lighting performance properties with a plurality of structural components defined as building geometry of an architectural space model in a three-dimensional computer-aided design (3D CAD) environment. At stage 1108, embodiments can formulate an environmental daylighting model associated with a designated geographical location for the architectural space model, a designated orientation for the architectural space model, and a plurality of keytimes. The architectural space model and the environmental daylighting model can be communicated to a lighting rendering engine remote from the lighting modeling engine at stage 1112. At stage 1116, embodiments can receive, at the lighting modeling engine from the lighting rendering engine, lighting rendering data computed by the daylighting rendering engine by ray-tracing the architectural space model as a function of the structural components, the lighting performance properties, and the environmental daylighting model at each keytime. A plurality of images can be output at stage 1120, via an interface of the lighting modeling engine, each graphically representing, for a respective one of the keytimes, a depiction of the architectural space model and a distributed lighting performance metric computed as a function of the lighting rendering data.

The methods disclosed herein include one or more actions for achieving the described method. The method and/or actions can be interchanged with one another without departing from the scope of the claims. In other words, unless a specific order of actions is specified, the order and/or use of specific actions can be modified without departing from the scope of the claims.

The functions described can be implemented in hardware, software, firmware, or any combination thereof. If implemented in software, the functions can be stored as one or more instructions on a tangible computer-readable medium. A storage medium can be any available tangible medium that can be accessed by a computer. By way of example, and not limitation, such computer-readable media can include RAM, ROM, EEPROM, CD-ROM, or other optical disk storage, magnetic disk storage, or other magnetic storage devices, or any other tangible medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

A computer program product can perform certain operations presented herein. For example, such a computer program product can be a computer readable tangible medium having instructions tangibly stored (and/or encoded) thereon, the instructions being executable by one or more processors to perform the operations described herein. The computer program product can include packaging material. Software or instructions can also be transmitted over a transmission medium. For example, software can be transmitted from a website, server, or other remote source using a transmission medium such as a coaxial cable, fiber optic cable, twisted pair, digital subscriber line (DSL), or wireless technology such as infrared, radio, or microwave.

Further, modules and/or other appropriate means for performing the methods and techniques described herein can be downloaded and/or otherwise obtained by suitable terminals and/or coupled to servers, or the like, to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized. Features implementing functions can also be physically located at various positions, including being distributed such that portions of functions are implemented at different physical locations.

In describing the present invention, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes and other characteristics need not be exact, but can be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations including, for example, tolerances, measurement error, measurement accuracy limitations and other factors known to those of skill in the art, can occur in amounts that do not preclude the effect the characteristic was intended to provide. Numerical data can be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described. A plurality of items can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items can be used alone or in combination with other listed items. The term “alternatively” refers to selection of one of two or more alternatives, and is not intended to limit the selection to only those listed alternatives or to only one of the listed alternatives at a time, unless the context clearly indicates otherwise. The term “coupled” as used herein does not require that the components be directly connected to each other. Instead, the term is intended to also include configurations with indirect connections where one or more other components can be included between coupled components. For example, such other components can include amplifiers, attenuators, isolators, directional couplers, redundancy switches, and the like. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples. As used herein, a “set” of elements is intended to mean “one or more” of those elements, except where the set is explicitly required to have more than one or explicitly permitted to be a null set.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein can be utilized. Accordingly, the appended claims include within their scope such processes, machines, manufacture, compositions of matter, means, methods, or actions.

What is claimed is:

1. A method for simulation and analysis of lighting performance in architectural modeling environments, the method comprising:
associating, with a processor-implemented lighting modeling engine, lighting performance properties with a plurality of structural components defined as building geometry of an architectural space model in a three-dimensional computer-aided design (3D CAD) environment;
formulating an environmental daylighting model associated with a designated geographical location for the architectural space model, a designated orientation for the architectural space model, and a plurality of keytimes;
communicating the architectural space model and the environmental daylighting model to a lighting rendering engine remote from the lighting modeling engine;
receiving, at the lighting modeling engine from the lighting rendering engine, lighting rendering data computed by the daylighting rendering engine by ray-tracing the architectural space model as a function of the structural components, the lighting performance properties, and the environmental daylighting model at each keytime; and
outputting, via an interface of the lighting modeling engine, a plurality of images, each graphically representing, for a respective one of the keytimes, a depiction of the architectural space model and a distributed lighting performance metric computed as a function of the lighting rendering data.

2. The method of claim 1, wherein the lighting performance properties indicates at least one of a visible transmittance measure, an ultraviolet transmittance measure, an opacity measure, a reflectivity measure, or a glare reduction measure.

3. The method of claim 1, wherein the architectural space model comprises 3D CAD model geometry that defines at least one of a room, a plurality of rooms, a floor of a building, a plurality of contiguous architectural spaces, or an architecturally defined portion of an architectural space that includes the architectural space model.

4. The method of claim 1, wherein at least one of the plurality of structural components is a wall, and at least another of the plurality of structural components is selected from the group comprising: a window; a window pane; a louvre; and a window treatment.

5. The method of claim 1, further comprising:
receiving a designation of the geographical location for the architectural space model via the interface of the lighting modeling engine by receiving at least one of a geographic place name or a set of geographical coordinates.

6. The method of claim 5, further comprising:
identifying one of a set of predesignated geographical locations as closest to the received designation of the geographical location,
the environmental daylighting model is formulated according to a set of stored environmental data associated with the identified predesignated geographical location.

7. The method of claim 1, wherein the architectural space model comprises an artificial lighting layout defining placement and illuminance properties of at least one artificial light impacting illumination of the architectural space model.

8. The method of claim 1, wherein:
the lighting rendering engine comprises the RADIANCE Synthetic Imaging System; and
the environmental daylighting model comprises a sky dome definition compatible with the RADIANCE Synthetic Imaging System.

9. The method of claim 1, wherein the lighting rendering engine is remote from the lighting modeling engine and in communication with the lighting modeling engine over a communications network.

10. The method of claim 1, wherein each keytime represents a time of day.

11. The method of claim 1, wherein each keytime represents an annual season.

12. The method of claim 1, wherein the lighting rendering data comprises at least one of daylight coefficients, artificial light coefficients, or illuminance measures.

13. The method of claim 1, wherein outputting the plurality of images comprises displaying the images in succession in such a way as to visually depict changes in the distributed lighting performance metric across the images.

14. The method of claim 1, wherein outputting the plurality of images comprises displaying each image in juxtaposition to at least one other of the images in such a way as to visually depict changes in the distributed lighting performance metric across the juxtaposed images.

15. The method of claim 1, wherein outputting at least one of the plurality of images to graphically represent, for the respective one of the keytimes, the depiction of the architectural space model and the distributed lighting performance metric computed as a function of the lighting rendering data comprises displaying a two-dimensional rendered image of the architectural space model with the distributed lighting performance metric represented by variations in color across a plurality of regions of the image.

16. The method of claim 1, wherein outputting at least one of the plurality of images to graphically represent, for the respective one of the keytimes, the depiction of the architectural space model and the distributed lighting performance metric computed as a function of the lighting rendering data comprises displaying a two-dimensional rendered image of the architectural space model with the distributed lighting performance metric represented by numerical data overlaid on the image.

17. The method of claim 1, further comprising:
computing, by the lighting modeling engine, the plurality of images to graphically represent the depiction of the architectural space model comprises and the distributed lighting performance metric as a function of the lighting rendering data.

18. The method of claim 17, further comprising:
communicating, to the lighting rendering engine for computation of the lighting rendering data, at least one of: a clip plane that transects the architectural space model, a selected viewpoint, or a selected camera type.

19. A system for simulation and analysis of lighting performance in architectural modeling environments, the method comprising:
a data storage system having, stored thereon, an architectural space model in a three-dimensional computer-aided design (3D CAD) environment; and
a set of processors that is communicatively coupled with the data storage system and operates to:
associate lighting performance properties with a plurality of structural components defined as building geometry of the architectural space model;
formulate an environmental daylighting model associated with a designated geographical location for the architectural space model, a designated orientation for the architectural space model, and a plurality of keytimes;
communicate the architectural space model and the environmental daylighting model to a lighting rendering engine;
receive, from the lighting rendering engine, lighting rendering data computed by the daylighting rendering engine by ray-tracing the architectural space model as a function of the structural components, the lighting performance properties, and the environmental daylighting model at each keytime; and
output, via a graphical user interface, a plurality of images, each graphically representing, for a respective one of the keytimes, a depiction of the architectural space model and a distributed lighting performance metric computed as a function of the lighting rendering data.

20. The system of claim 19, further comprising the lighting rendering engine.
